(19) United States
(12) Patent Application Publication
(10) Pub. No.: US 2014/0103822 A1
(43) Pub. Date: Apr. 17, 2014

(54) ELECTRONIC APPARATUS

(71) Applicant: KABUSHIKI KAISHA TOSHIBA, Tokyo (JP)

(72) Inventors: Hirofumi SAKURAI, Kumagaya-shi (JP); Hisayuki MIHARA, Honjo-shi (JP); Yoshihiro MORITO, Fukaya-shi (JP)

(73) Assignee: KABUSHIKI KAISHA TOSHIBA, Tokyo (JP)

(21) Appl. No.: 13/903,756

(22) Filed: May 28, 2013

(30) Foreign Application Priority Data
Oct. 12, 2012 (JP) 2012-227428

(51) Int. Cl. F21K 99/00; H05B 33/08

(52) U.S. Cl. CPC F21K 9/00; H05B 33/0842
USPC 315/186; 362/249.06

(57) ABSTRACT

According to one embodiment, an electric apparatus comprises a panel, a plurality of substrates at a back side of the panel, a plurality of first LEDs spaced apart from each other with gaps, on each of the substrates, and configured to illuminate the panel from the back side of the panel, and a plurality of second LEDs additionally arranged in the gaps at a substantially central portion in a lateral direction of the panel, of the gaps on each of the substrates, and configured to illuminate the panel from the back side of the panel.

### CROSS-REFERENCE TO RELATED APPLICATIONS

This application is based upon and claims the benefit of priority from Japanese Patent Application No. 2012-227428, filed Oct. 12, 2012; the entire contents of which are incorporated herein by reference.

### FIELD

Embodiments described herein relate generally to an electronic apparatus comprising a display screen.

### BACKGROUND

Embodiments described herein disclose a backlight unit to illuminate a liquid crystal panel.

The problem of the embodiments is to provide an electronic apparatus in which brightness of the screen can be improved.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an image displaying apparatus of a first embodiment;

FIG. 2 is an exemplary exploded perspective view showing the image displaying apparatus shown in the first embodiment;

FIG. 3 is an exemplary front view showing arrangement of an LED bar shown in FIG. 2;

FIG. 4 is an exemplary front view showing arrangement of an LED bar of an image displaying apparatus of a second embodiment;

FIG. 5 is an exemplary front view showing arrangement of a first LED bar and a second LED bar of an image displaying apparatus of a third embodiment;

FIG. 6 is an exemplary view showing a part of a connected state and a driver circuit of an LED bar of an image displaying apparatus of a fourth embodiment; and

FIG. 7 is an exemplary front view showing arrangement of an LED bar of an image displaying apparatus of a fifth embodiment.

### DETAILED DESCRIPTION

Various embodiments will be described hereinafter with reference to the accompanying drawings.

In general, according to one embodiment, an electric apparatus comprises a panel, a plurality of substrates at a back side of the panel, a plurality of first light-emitting diodes (LEDs) spaced apart from each other with gaps, on each of the substrates, and configured to illuminate the panel from the back side of the panel, and a plurality of second LEDs additionally arranged in the gaps at a substantially central portion in a lateral direction of the panel, of the gaps on each of the substrates, and configured to illuminate the panel from the back side of the panel.

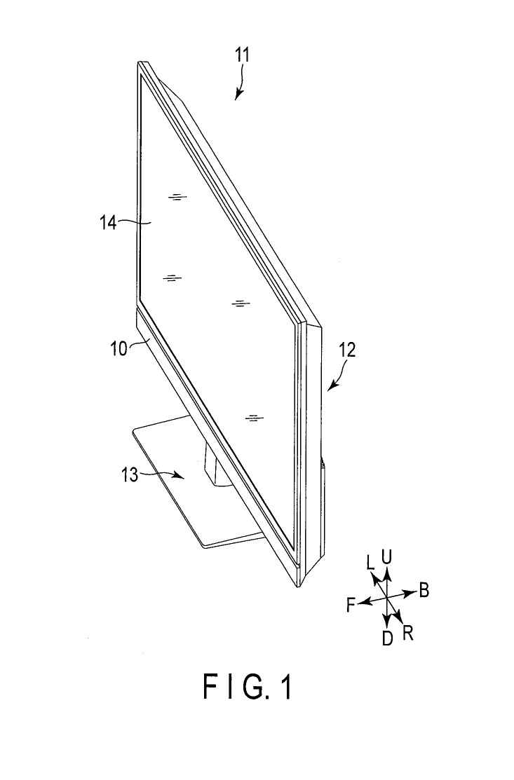

An image displaying apparatus of a first embodiment will be described below with reference to FIG. 1 to FIG. 3. As shown in FIG. 1, an image displaying apparatus 11 (TV) of the embodiment is an example of an electronic apparatus, and has an outer appearance of a substantially elongated shape. In the embodiments described below, a front side (i.e., user side) is defined as a front direction F, a back side seen from the user is defined as a back direction B, a left side seen from the user is defined as a left direction L, a right side seen from the user is defined as a right direction R, an upper side seen from the user is defined as an upper direction U, and a lower side seen from the user is defined as a lower direction D. In addition, a lateral direction corresponds to the right and left directions, and a longitudinal direction corresponds to the upper and lower directions.

As shown in FIG. 1, the image displaying apparatus 11 comprises a displaying portion 12 equipped with a display screen and a supporting portion 13 (foot portion; stand) configured to support the displaying portion 12. The image displaying apparatus 11 employs what is called a direct backlight, and a light source (LED) used as the backlight is arranged in lattice form on a rear side (back surface) of a liquid crystal panel 14.

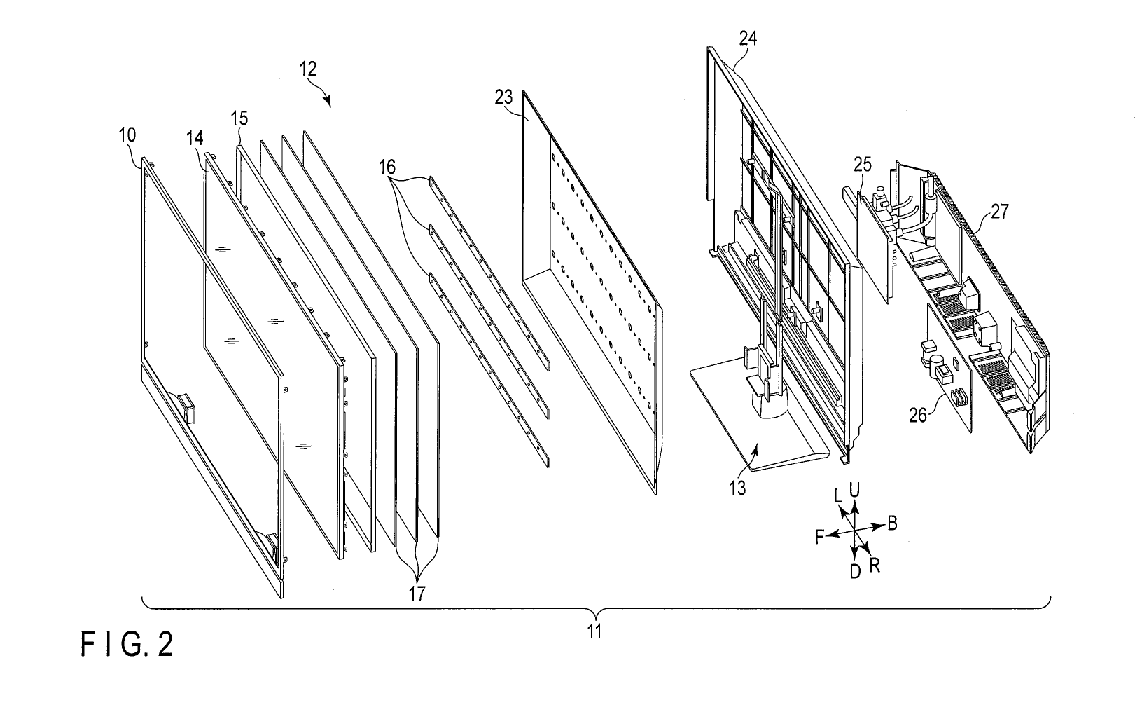

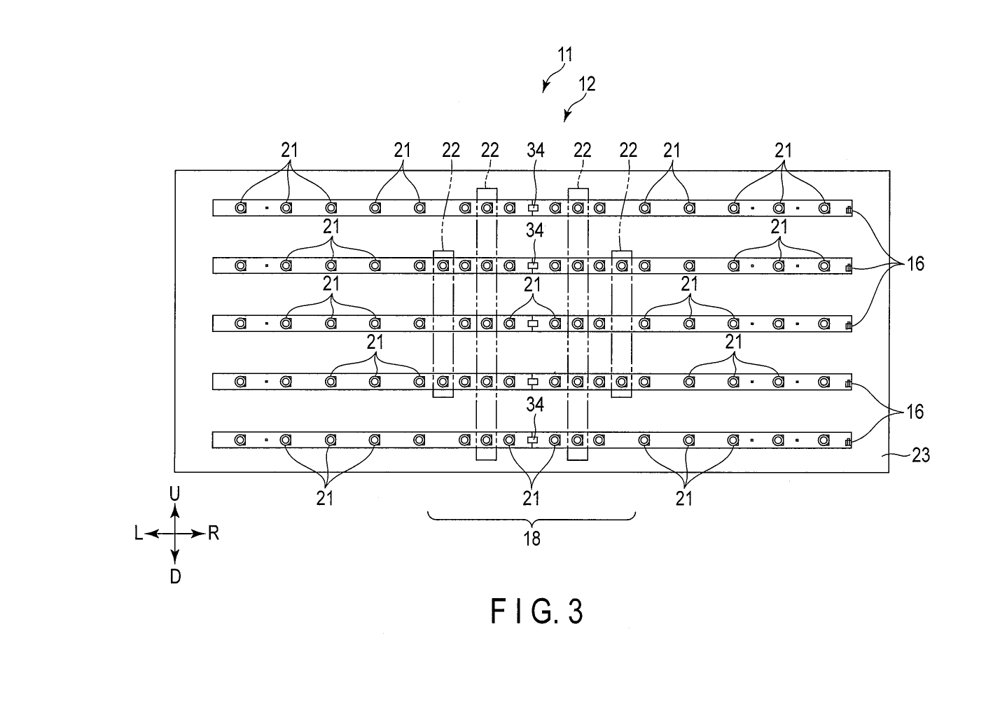

As shown in FIG. 2 and FIG. 3, the displaying portion 12 is constituted by superposing the following constituent elements. The displaying portion 12 comprises a frame-shaped front bezel 10 configured to surround a front frame of the liquid crystal panel 14, the flat liquid crystal panel (panel; display panel) 14 configured to display a display screen, a fixing metal part 15 configured to fix the liquid crystal panel 14, a plurality of optical sheets 17 having various optical functions such as increasing light of LED bars 16 (backlight), the plurality of (five) LED bars 16 in which a plurality of first LEDs 21 and a plurality of second LEDs 22 are arranged, a reflection sheet 23, a back cover 24, an image circuit board 25 attached to the back cover 24, a power supply board 26 (controller) attached to the back cover 24 and comprising an LED drive circuit, and a unit cover 27 configured to cover the image circuit board 25 and the power supply board 26. A casing of the image displaying apparatus 11 is constituted by the front bezel 10, the back cover 24, and the unit cover 27. In FIG. 2, a small number of LEDs 16 are shown.

Each of the LED bars 16 (substrates) is shaped in an elongated plate. The LED bars 16 are parallel to each other on the back side of the liquid crystal panel 14. There is a gap between every two LED bars 16. Each of the LED bars 16 is fixed on, for example, a casing such as the back cover 24 or on the liquid crystal panel 14. Each of the LED bars 16 is constituted by connecting two substrates having the same length by a connector 34 as a long substrate (cf. FIG. 3).

As shown in FIG. 3, a plurality of LEDs are serial and spaced apart with predetermined intervals on each of the LED bars 16. In other words, the plurality of first LEDs 21 spaced apart from each other with predetermined intervals (e.g., certain intervals) and the second LEDs 22 (LEDs for boost) additionally arranged in gaps between the first LEDs 21 are provided on each of the LED bars 16. In the present embodiment, LEDs having the same output as the first LEDs 21 are used as the second LEDs 22. The first LEDs 21 and the second LEDs 22 are what is called wide light distribution type LEDs by which the liquid crystal panel 14 can be illuminated from the back side.

The second LEDs 22 are provided at a substantially central portion 18 in the lateral direction of the liquid crystal panel 14. In this case, the substantially central portion 18 indicates a range covering, for example, ⅓ to ¼ of the lateral length of the liquid crystal panel 14, near a middle portion in the lateral direction of the liquid crystal panel 14.

For this reason, the LEDs are arranged at high density at the substantially central portion 18 in the lateral direction of the liquid crystal panel 14. Since the LEDs (first LEDs 21 and second LEDs 22) are arranged at high density at the central portion of the liquid crystal panel 14, the image displaying apparatus 11 which is brighter at the central portion is implemented. In the present embodiment, arrangement of the first LEDs 21 and the second LEDs 22 is symmetrical laterally and vertically.

According to the first embodiment, the image displaying apparatus 11 comprises the panel, the plurality of substrates, the plurality of first LEDs 21 spaced apart from each other with intervals, on each of the substrates, to illuminate the panel from the back side of the panel, and the plurality of second LEDs 22 additionally arranged in the gaps at the substantially central portion 18 in the lateral direction of the panel to illuminate the panel from the back side of the panel.

There is a statistic research result that customers visiting an electric appliance store or an electric product department first notice a brighter image displaying apparatus 11, of image displaying apparatuses 11 placed in the department. According to the above-described structure, since the second LEDs 22 can be additionally arranged at the substantially central portion 18 in the lateral direction of the panel, the brightness of the screen can be enhanced at the central portion (i.e., the boost effect of the backlight can be achieved at the central portion of the screen). The probability of sales of the image displaying apparatuses 11 can be increased when they are arranged at, for example, the department, while maintaining the power saving, as compared with brightening the entire screen. A competitive power of goods can be thereby increased. Furthermore, according to the above-described structure, a small number of second LEDs 22 need only to be added, and the image displaying apparatus 11 having a bright screen can be implemented at a minimum cost.

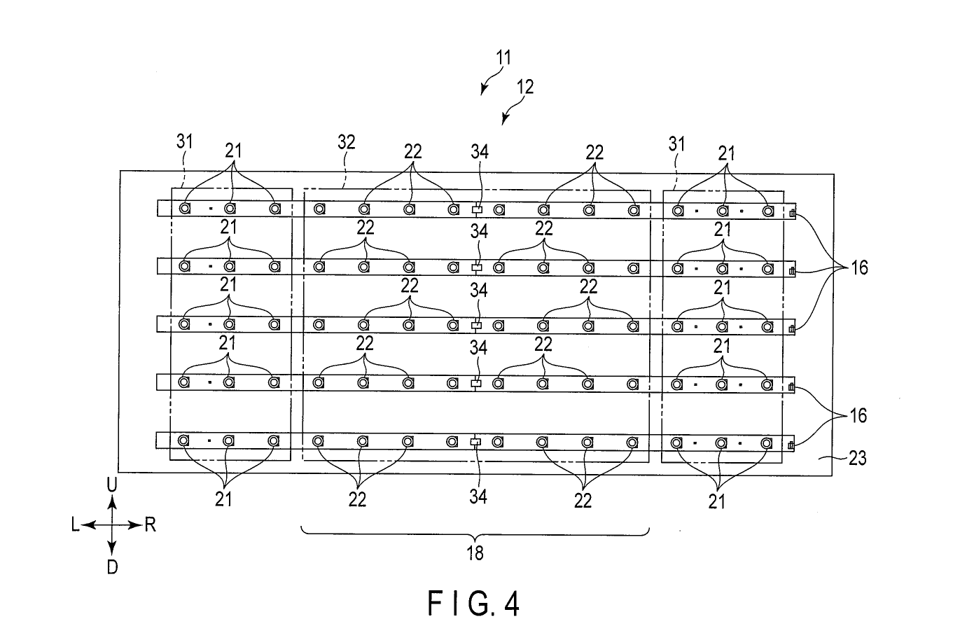

Next, an image displaying apparatus of a second embodiment which is an example of the electronic apparatus will be described with reference to FIG. 4. The image displaying apparatus of the second embodiment is different from that of the first embodiment with respect to the structure of a second LED 22, but common to the first embodiment with respect to the other portions. For this reason, the different portions will be mainly described and the portions common to the first embodiment will not be shown or described.

Each of LED bars 16 (substrates) is shaped in an elongated plate. The LED bars 16 are parallel to each other, and there is a gap between every two LED bars 16. Each of the LED bars 16 is fixed on a casing such as a back cover 24 or a liquid crystal panel 14.

A plurality of LEDs are serial and spaced apart with predetermined intervals on each of the LED bars 16. A plurality of first LEDs 21 spaced apart from each other with predetermined intervals and a plurality of second LEDs 22 spaced apart from each other with predetermined intervals are provided on each of the LED bars 16. In the present embodiment, the first LEDs 21 are arranged near both end portions in the lateral direction of the liquid crystal panel 14, and the second LEDs 22 are arranged at a substantially central portion 18 in the lateral direction of the liquid crystal panel 14. In other words, an arrangement region of the second LEDs 22 (second arrangement region 32) is provided near the central portion in the lateral direction of the LED bars 16, and an arrangement region of the first LEDs 21 (first arrangement region 31) is provided near both of the end portions in the lateral direction of the LED bars 16. In this case, the substantially central portion 18 indicates a range covering, for example, ⅓ to ¼ of the lateral length of the liquid crystal panel 14, near a middle portion in the lateral direction of the liquid crystal panel 14.

The first LEDs 21 are arranged on the LED bars 16 (substrates) and spaced apart from each other with predetermined intervals. The second LEDs 22 are arranged on the LED bars 16 (substrates) and spaced apart from each other with predetermined intervals.

An LED having a higher output (higher luminance or brightness) than the first LED 21 is used as the second LED 22. More specifically, the first LED 21 is a general one-chip LED while a multiple-chip type LED in which a plurality of LED chips are built in the same package or a large-area type LED in which the area of the LED chip is increased as compared with a general LED chip is used as the second LED 22.

In the second embodiment, the central portion of the screen is displayed brightly since the high-output second LEDs 22 are concentrated at the central portion in the lateral direction of the liquid crystal panel (panel/display panel) 14.

According to the second embodiment, the image displaying apparatus 11 comprises the panel, a plurality of substrates, the plurality of first LEDs 21 arranged on each of the substrates, near the end portions in the lateral direction of the panel, to illuminate the panel from the back side of the panel, and the plurality of second LEDs 22 arranged on each of the substrates, at the substantially central portion 18 in the lateral direction of the panel and having a greater output than the first LEDs 21, to illuminate the panel from the back side of the panel.

According to this structure, the central portion of the screen can be brightened and a competitive power of the image displaying apparatus 11 at the department can be increased since the plurality of high-out second LEDs 22 can be arranged at the substantially central portion 18 in the lateral direction of the panel.

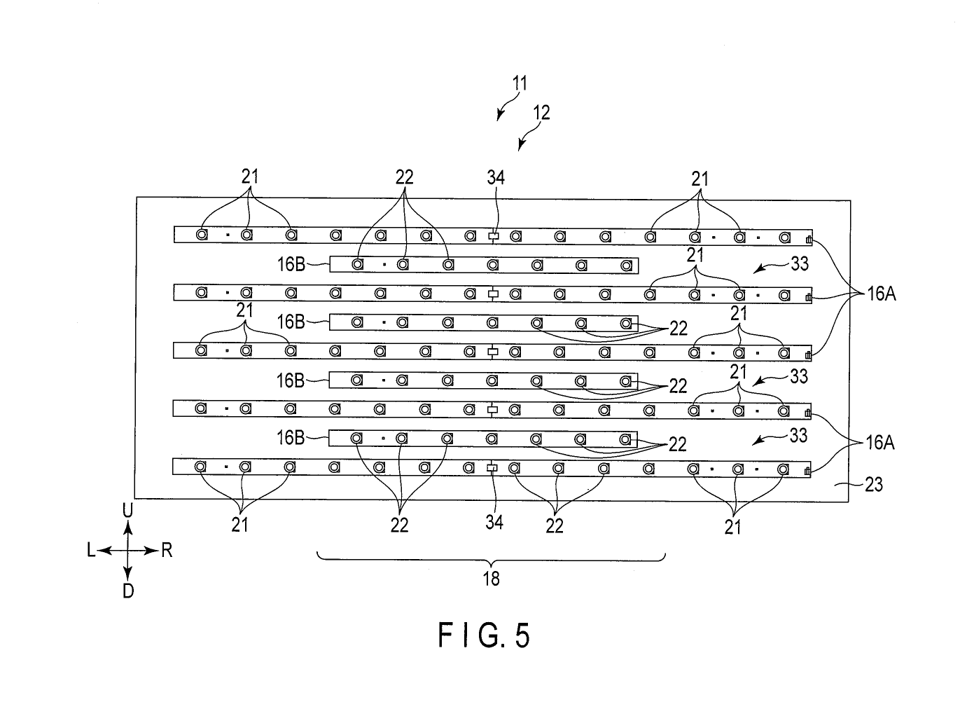

Next, an image displaying apparatus of a third embodiment which is an example of the electronic apparatus will be described with reference to FIG. 5. An image displaying apparatus 11 of the third embodiment is different from that of the first embodiment with respect to providing a second LED bar 16B, but common to the first embodiment with respect to the other portions. For this reason, the different portions will be mainly described and the portions common to the first embodiment will not be shown or described.

A displaying portion 12 comprises a plurality of first LED bars 16A (first substrates) on which a plurality of first LEDs 21 are arranged, and a plurality of second LED bars 16B (second substrates) on which a plurality of second LEDs 22 are arranged.

Each of the first LED bars 16A is shaped in an elongated plate. The first LED bars 16A are parallel to each other, and there is a gap 33 between every two first LED bars 16A. Each of the first LED bars 16A is constituted by connecting two substrates having the same length by a connector 34 as a long substrate. The plurality of first LEDs 21 are serial and spaced apart with predetermined intervals on each of the first LED bars 16A.

The plurality of second LED bars 16B are arranged in the above-described gaps 33. In other words, the first LED bars 16A and the second LED bars 16B are arranged alternately. Each of the second LED bars 16B is shaped in an elongated plate, and has a length which is half of the length of the first LED bar 16A. Therefore, if two substrates to be used as the second LED bar 16B is connected by the connector 34, a substrate which can be used as the first LED bar 16A can be constituted.

The second LED bars 16B are arranged at a substantially central portion 18 in the lateral direction of the liquid crystal panel 14. The plurality of second LEDs 22 are serial and spaced apart with predetermined intervals on each of the second LED bars 16B. In the present embodiment, the second LEDs 22 are constituted by the same LEDs as the first LEDs 21. In addition, the second LEDs 22 are arranged alternately with the first LEDs 21 on the first LED bars 16A, in the lateral direction of the liquid crystal panel 14.

The second LED bars 16B are provided at a substantially central portion 18 in the lateral direction of the liquid crystal panel 14. In this case, the substantially central portion 18 indicates a range covering, for example, ⅓ to ¼ of the lateral length of the liquid crystal panel 14, near a middle portion in the lateral direction of the liquid crystal panel 14.

Each of the first LED bars 16A (substrates) and each of the second LED bars 16B are fixed on a casing such as a back cover 24 or the liquid crystal panel 14.

According to the third embodiment, the image displaying apparatus 11 comprises the panel, a plurality of the first substrates spaced apart with gaps 33 behind the panel, the plurality of first LEDs 21 arranged on each of the first substrates to illuminate the panel from the back side of the panel, a plurality of the second substrates additionally provided in gaps behind the panel, at a substantially central portion 18 in a lateral direction of the panel, and the plurality of second LEDs 22 arranged on each of the second substrates to illuminate the panel from the back side of the panel.

According to this structure, the second substrates and the second LEDs 22 can be additionally provided at the substantially central portion 18 in the lateral direction of the panel. The image displaying apparatus 11 which is bright at the central portion, preferable in outer appearance, and capable of attracting customers' attention can be thereby provided.

In addition, the plurality of first LEDs 21 and the plurality of second LEDs 22 are arranged alternately with each other in the lateral direction of the panel. According to this structure, the image displaying apparatus 11 in which the central portion of the screen is bright and the unevenness in display is small can be provided.

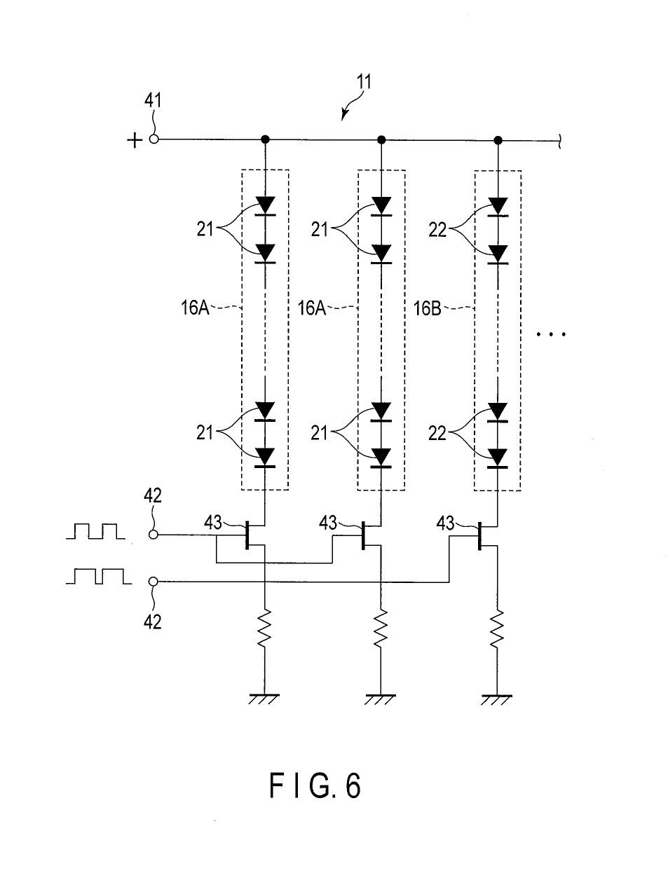

Next, an image displaying apparatus 11 of a fourth embodiment which is an example of the electronic apparatus will be described with reference to FIG. 6. The image displaying apparatus 11 of the fourth embodiment is different from that of the third embodiment with respect to drive control of a second LED bar 16B, but common to the first embodiment with respect to the other portions. For this reason, the different portions will be mainly described and the portions common to the third embodiment will not be shown or described.

In the present embodiment, the image displaying apparatus 11 comprises first LEDs 21 of first LED bars 16A and second LEDs 22 of second LEDs 16B in the same arrangement as the third embodiment shown in FIG. 5.

FIG. 6 shows an example of a connected state and a driver circuit for energizing and driving the first LEDs 21 and the second LEDs 22. An anode of a most upstream first LED 21, of the plurality of first LEDs 21, is connected to a positive (+) power supply terminal 41 connected to a power supply board 26 (controller). A cathode of a most downstream first LED 21, of the plurality of first LEDs 21, is connected to a negative (−) power supply terminal 42 of the power supply board 26 through a switching element 43.

Quantity of light emission of the first LED 21 can be adjusted by varying a duty ratio by a pulse width modulation signal supplied from the power supply board 26 to the switching element 43 (i.e., by executing PWM control).

An anode of a most upstream second LED 22, of the plurality of second LEDs 22, is connected to the positive (+) power supply terminal 41 of the power supply board 26. A cathode of a most downstream second LED 22, of the plurality of second LEDs 22, is connected to the negative (−) power supply terminal 42 of the power supply board 26 through the switching element 43. As shown in FIG. 6, wiring for the second LED 22 is provided independently of wiring for the first LED 21.

Quantity of light emission of the second LED 22 can be adjusted by varying a duty ratio by a pulse width modulation signal supplied from the power supply board 26 to the switching element 43 (i.e., by executing PWM control).

In the present embodiment, the duty ratio of the second LED 22 is set to be higher than the duty ratio of the first LED 21. More specifically, the duty ratio of the first LED 21 is substantially 0.5 (50%) while the duty ratio of the second LED 22 is substantially 0.8 (80%). For this reason, the quantity of light emission from the second LED 22 is great as compared with the first LED 21. The image displaying apparatus 11 in which a substantially central portion 18 is bright in the lateral direction of the liquid crystal panel (panel/display panel) 14 is thus implemented.

According to the present embodiment, the image displaying apparatus 11 comprises a controller configured to flow a current to the plurality of first LEDs 21 and the plurality of second LEDs 22 and set the duty ratio of the second LED to be higher than the duty ratio of the first LED under the PWM control.

According to this structure, the second LEDs 22 having the great quantity of light emission can be additionally provided at the substantially central portion 18 in the lateral direction of the panel. The image displaying apparatus 11 which is bright at the central portion, preferable in outer appearance, and capable of attracting customers' attention can be thereby provided. In addition, the image displaying apparatus 11 which is capable of brightening the screen under simple control and has a preferable impression at a minimum additional cost can be provided.

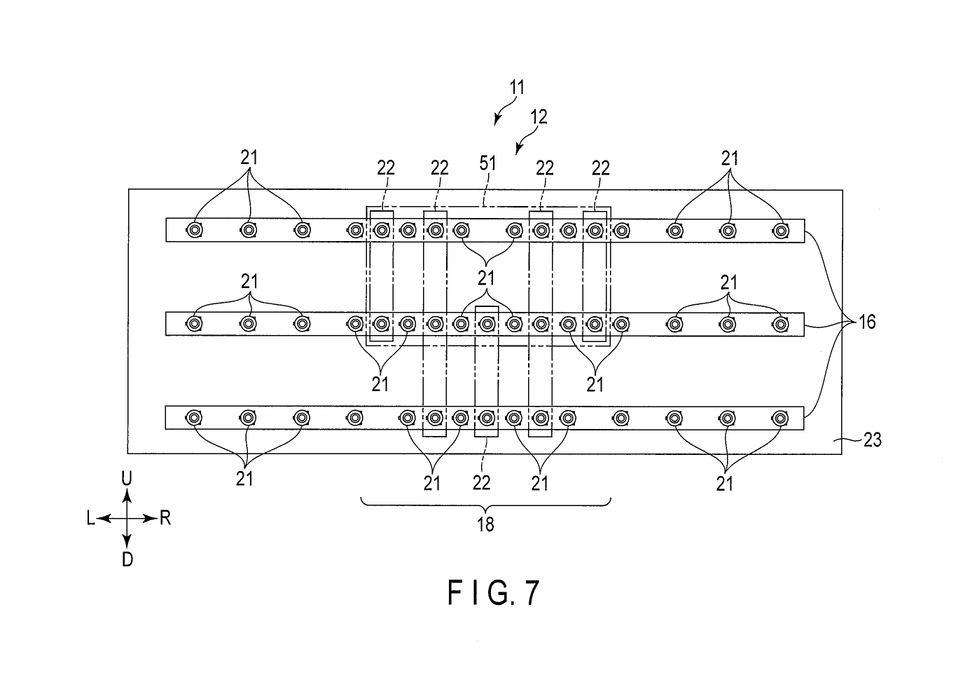

Next, an image displaying apparatus of a fifth embodiment which is an example of the electronic apparatus will be described with reference to FIG. 7. The image displaying apparatus of the fifth embodiment is different from that of the first embodiment with respect to the number of LED bars 16 and arrangement of second LEDs 22, but common to the first embodiment with respect to the other portions. For this reason, the different portions will be mainly described and the portions common to the first embodiment will not be shown or described.

As shown in FIG. 7, a displaying portion 12 comprises a plurality of (for example, three) LED bars 16. In the present embodiment, each of the LED bars 16 does not use a connector 34.

A plurality of LEDs are serial and spaced apart with predetermined intervals on each of the LED bars 16. In other words, a plurality of first LEDs 21 spaced apart from each other with predetermined intervals and second LEDs 22 (LEDs for boost) additionally provided in gaps between the first LEDs 21 are provided on each of the LED bars 16. In the present embodiment, LEDs having the same output as the first LEDs 21 are used as the second LEDs 22.

The second LEDs 22 are provided in the gaps between the first LEDs 21 at a substantially central portion 18 in the lateral direction of the liquid crystal panel 14. In other words, the second LEDs 22 are arranged at the substantially central portion 18 in the lateral direction of the liquid crystal panel 14. In this case, the substantially central portion 18 indicates a range covering, for example, ⅓ to ¼ of the lateral length of the liquid crystal panel 14, near a middle portion in the lateral direction of the liquid crystal panel 14.

Furthermore, in the present embodiment, unlike the first embodiment, the second LEDs 22 are concentrated at the substantially central portion 18 in the lateral direction of the liquid crystal panel 14 and at a substantially upper portion 51 in a vertical direction of the liquid crystal panel 14. In this case, the substantially upper portion 51 indicates a range covering, for example, half to ¾ of the vertical length of the liquid crystal panel 14, at an upper portion in the vertical direction of the liquid crystal panel 14.

For this reason, the LEDs are arranged at a high density at the substantially upper portion 51 of the substantially central portion 18 of the liquid crystal panel 14. Since the LEDs (first LEDs 21 and second LEDs 22) can be thus arranged at a high density on the upper side of the central portion of the liquid crystal panel 14, the image displaying apparatus 11 which is bright at the central portion of the liquid crystal panel 14 can be implemented.

According to the present embodiment, the second LEDs 22 are arranged in the gaps at the substantially upper portion 51 in the vertical direction of the panel.

Recently, the image displaying apparatus 11 (television) has become greater in size, and the image displaying apparatus 11 has been frequently installed at a position at which a user looks down with the user's viewpoint. According to the above-described structure, the position close to the user's eyes can be particularly brightened on the display screen. The image displaying apparatus 11 which has a reduced unnatural impression and which is preferable in outer appearance and capable of attracting customers' attention can be thereby provided. In addition, the image displaying apparatus in which the number of additional LEDs is small and which has a preferable impression at a minimum additional cost can be provided.

The image displaying apparatus 11 (electronic apparatus) is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a panel;
a plurality of substrates at a back side of the panel;
a plurality of first light-emitting diodes (LEDs) on each of the plurality of substrates, spaced apart from each other with gaps, and configured to illuminate the panel; and
a plurality of second LEDs arranged in the gaps at a substantially central portion in a lateral direction of the panel, and configured to illuminate the panel.

2. The electronic apparatus of claim 1, wherein the second LEDs are arranged in the gaps at a substantially upper portion in a vertical direction of the panel.

3. An electronic apparatus comprising:
a panel;
a plurality of substrates at a back side of the panel;
a plurality of first light-emitting diodes (LEDs) on each of the plurality of substrates near end portions in a lateral direction of the panel, and configured to illuminate the panel; and
a plurality of second LEDs on each of the plurality of substrates at a substantially central portion in a lateral direction of the panel, and configured to have a greater luminance than the first LEDs and to illuminate the panel.

4. An electronic apparatus comprising:
a panel;
a plurality of first substrates at a back side of the panel and spaced apart from each other with gaps;
a plurality of first light-emitting diodes (LEDs) on each of the plurality of first substrates and configured to illuminate the panel;
a plurality of second substrates in the gaps at a substantially central portion in a lateral direction of the panel; and
a plurality of second LEDs on each of the plurality of second substrates, and configured to illuminate the panel.

5. The electronic apparatus of claim 4, wherein the plurality of first LEDs and the plurality of second LEDs are alternately positioned in the lateral direction of the panel.

6. The electronic apparatus of claim 4, comprising a controller configured to control flow of an electric current to the plurality of first LEDs and the plurality of second LEDs and to set a duty ratio of the second LEDs to be higher than a duty ratio of the first LEDs under pulse width modulation control.
